(19) United States
(12) Patent Application Publication
(10) Pub. No.: US 2006/0017410 A1
(43) Pub. Date: Jan. 26, 2006

(54) Two-beam scanning optical apparatus

(75) Inventors: Kazuyoshi Noguchi, Toyokawa-shi (JP); Hidekazu Takahama, Nagoya-shi (JP); Takahiro Tsutsumi, Toyohashi-shi (JP); Toru Maegawa, Hino-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/007,229

(22) Filed: Dec. 9, 2004

(30) Foreign Application Priority Data
Jul. 26, 2004 (JP) 2004-217261

(51) Int. Cl. G09G 1/04

(52) U.S. Cl. 315/382

(57) ABSTRACT

A two-beam scanning optical apparatus includes a first beam generating device, a second beam generating device, a judging unit which judges whether the second beam generating device is operating normally or not, a raster signal processing unit which outputs a raster signal each time if the judging unit judges that the second beam generating device is operable, and which outputs a raster signal every other time if the judging unit judges that the second beam generating device is not operable and a control unit which performs image formation by using the first beam generating device and the second beam generating device based on the raster signal output every other time, and which performs image formation by using only the first beam generating device based on the raster signal output each time.

This application is based on Japanese Patent Application(s) No(s). 2004-217261 filed in Japan on Jul. 26, 2004, the entire content of which is hereby incorporated by reference.

### BACKGROUND OF THE INVENTION

1. Field of the Invention

The present invention relates to a two-beam scanning optical apparatus, and more particularly to a two-beam scanning optical apparatus which forms an image on a photoconductor by simultaneously projecting two beams one spaced a prescribed distance apart from the other in a sub-scanning direction.

2. Description of the Related Art

In the field of electrophotographic image forming apparatus, it has been widely practiced in recent years to form an electrostatic latent image on a photoconductor by using a two-beam scanning optical apparatus equipped with a light emitting device array that emits two beams simultaneously. When provisions are made to form an image by simultaneously projecting two beams one spaced a prescribed distance apart from the other in the sub-scanning direction, the system speed increases twice, and thus the printing throughput per unit time increases by a factor of two.

Accordingly, two-beam scanning optical apparatuses are used for high speed and middle speed machines, but their application to low speed machines is also being considered in order to reduce the cost through mass production of two-beam light emitting device arrays.

In a two-beam light emitting device array, if one light emitting device fails, the device array can no longer be used for its intended purpose and, as a result, the print head unit (at least a unit containing the scanning optical apparatus) must be replaced. However, in the case of low speed machines, it would be uneconomical to replace the print head unit because of an emission failure of one beam.

In view of this, in Japanese Unexamined Patent Publication No. 2003-145829, it is disclosed that, if one of the two beam generating devices deteriorates, printing operation is continued by using only the other normally operating device, while maintaining the resolution by switching the system speed to a second speed (one half the speed achievable with two beams). Such a control method, however, provides no more than an emergency measure, since the printing throughput drops by a factor of two, and eventually, replacement of the print head unit would become inevitable.

### OBJECT AND SUMMARY

Accordingly, it is an object of the present invention to provide a two-beam scanning optical apparatus which, even when one of the two beam generating devices has failed, can continue image formation by using the other normally operating beam generating device, without reducing the resolution or the system speed compared with the case of two-beam image formation.

To achieve the above object, according to a first invention, there is provided a two-beam scanning optical apparatus for forming an image on a photoconductor by simultaneously projecting a first beam and a second beam one spaced a prescribed distance apart from the other in a sub-scanning direction, the apparatus comprising a first memory section and a second memory section for holding per-line image data for a first beam generating device and a second beam generating device, respectively, a judging section which judges whether the first beam generating device and the second beam generating device are operating normally to emit light or a failure has occurred in any one of the beam generating devices, a memory control section which causes the image data to be written to and read from the first and second memory sections, a driver section which performs light emission control on the first beam generating device and the second beam generating device, a rotation control section which controls the rotation of a deflector which deflects the first beam and the second beam for scanning, a pixel clock control section which outputs a pixel clock signal and a raster signal processing section which outputs a raster synchronization signal, and wherein the rotation control section drives the deflector for rotation at all times with a number of revolutions that is used when forming an image with one beam, the pixel clock control section outputs the pixel clock signal at all times with a frequency that is used when forming an image with one beam, when it is judged by the judging section that one of the beam generating devices has failed but the other beam generating device is operating normally, the memory control section inhibits the writing of the image data to the memory section corresponding to the failed beam generating device, and causes the per-line data to be written to and read from the memory section corresponding to the normally operating beam generating device, when it is judged by the judging section that one of the beam generating devices has failed but the other beam generating device is operating normally, the driver section performs the light emission control on the normally operating beam generating device, and when it is judged by the judging section that one of the beam generating devices has failed but the other beam generating device is operating normally, the raster signal processing section generates the raster synchronization signal for each line scanned, while when it is judged by the judging section that the first beam generating device and the second beam generating device are operating normally, the raster signal processing section generates the raster synchronization signal by decimating raster signals.

In the two-beam scanning optical apparatus according to the first invention, when forming an image with two beams, the number of revolutions of the deflector and the frequency of the pixel clock signal are respectively set the same as the number of revolutions and the frequency that are used when forming an image with one beam, and the raster signal processing section generates the raster synchronization signal by decimating raster signals. The memory control section causes the per-line image data to be written to and read from the first and second memory sections. The driver section performs light emission control on the first beam generating device and the second beam generating device.

On the other hand, if a failure (including device deterioration) has occurred in one of the beam generating devices, one-beam image formation is performed using the other normally operating beam generating device. That is, since the number of revolutions of the deflector and the frequency of the pixel clock signal are respectively set the same as the number of revolutions and the frequency that are used when forming an image with one beam, as described above, the number of revolutions and the frequency are respectively maintained, and the raster signal processing section generates the raster synchronization signal for each line scanned. Further, the memory control section inhibits the writing of the image data to the memory section corresponding to the failed beam generating device. The driver section performs the light emission control on the normally operating beam generating device.

With the above control operations, even when one of the beam generating devices has failed, image formation can be continued by using the other normally operating beam generating device, without reducing the resolution or the system speed compared with the case of two-beam image formation. Even when driving with one beam, since the image quality does not degrade, nor does the printing throughput drop, there is no need to replace the print head unit, which is thus economical.

In the two-beam scanning optical apparatus according to the first invention, preferably the raster signal processing section is configured to be able to select whether the raster synchronization signal should be output based on a detection signal of the first beam or on a detection signal of the second beam, wherein when it is judged by the judging section that one of the beam generating devices has failed but the other beam generating device is operating normally, the raster signal processing section outputs the raster synchronization signal based on the detection signal of the normally operating beam.

According to a second invention, there is provided a two-beam scanning optical apparatus for forming an image on a photoconductor by simultaneously projecting a first beam and a second beam one spaced a prescribed distance apart from the other in a sub-scanning direction, the apparatus comprising a deflector which deflects the first beam and the second beam for scanning, a first memory section and a second memory section for holding per-line image data for a first beam generating device and a second beam generating device, respectively, a judging section which judges whether the second beam generating device is operating normally to emit light or a failure has occurred in the second beam generating device, a driver section which performs light emission control on the first beam generating device and the second beam generating device when it is judged by the judging section that the second beam generating device is operating normally, and which performs light emission control only on the first beam generating device when it is judged that the second beam generating device has failed, a write control section which causes the image data to be written to the first memory section and the second memory section when it is judged by the judging section that the second beam generating device is operating normally, and which causes the image data to be written only to the first memory section when it is judged that the second beam generating device has failed, a beam detecting section which outputs a beam detection signal by detecting the first beam or the second beam deflected for scanning, a raster signal processing section which outputs a raster signal each time, based on the beam detection signal, when it is judged by the judging section that the second beam generating device has failed, and which outputs a raster signal every other time, when it is judged that the second beam generating device is operating normally and a read control section which causes the image data to be read from the first memory section and the second memory section in accordance with a raster synchronization signal when it is judged by the judging section that the second beam generating device is operating normally, and which causes the image data to be read only from the first memory section in accordance with a raster synchronization signal when it is judged that the second beam generating device has failed.

In the two-beam scanning optical apparatus according to the second invention, as in the two-beam scanning optical apparatus according to the first invention, even when one of the beam generating devices has failed, image formation can be continued by using the other normally operating beam generating device, without reducing the resolution or the system speed compared with the case of two-beam image formation. Even when driving with one beam, since the image quality does not degrade, nor does the printing throughput drop, there is no need to replace the print head unit, which is thus economical.

According to a third invention, there is provided a two-beam scanning optical apparatus for forming an image on a photoconductor by simultaneously projecting a first beam and a second beam one spaced a prescribed distance apart from the other in a sub-scanning direction, the apparatus comprising a polygon mirror which deflects the first beam and the second beam for scanning, a driving section which drives the polygon mirror with a number of revolutions that is used when forming an image only with one beam, a memory section for holding image data, a judging section which judges whether a first beam generating device and a second beam generating device are operating normally to emit light or a failure has occurred in any one of the beam generating devices, a raster signal processing section which outputs a raster signal each time, when it is judged by the judging section that any one of the beam generating devices has failed, and which outputs a raster signal every other time, when it is judged that the beam generating devices are operating normally; and a control section which, when it is judged by the judging section that the beam generating devices are operating normally, performs image formation by using the first beam generating device and the second beam generating device based on the raster signal that is output every other time, and which, when it is judged that any one of the beam generating devices has failed, performs image formation by using only the normally operating beam generating device based on the raster signal that is output each time.

The raster signal processing section according to the third invention may include specifically a beam detecting section which outputs a beam detection signal by detecting the first beam or the second beam deflected by the polygon mirror for scanning, and may be configured to generate the raster signal based on the beam detection signal.

According to a fourth invention, there is provided a two-beam scanning optical apparatus for forming an image on a photoconductor by simultaneously projecting a first beam and a second beam one spaced a prescribed distance apart from the other in a sub-scanning direction, the apparatus comprising a polygon mirror which deflects the first beam and the second beam for scanning, a driving section which drives the polygon mirror with a number of revolutions that is used when forming an image only with one beam, a memory section for holding image data, a judging section which judges whether the second beam generating device is operating normally to emit light or a failure has occurred in the second beam generating device, a raster signal processing section which outputs a raster signal each time, when it is judged by the judging section that the second beam generating device has failed, and which outputs a raster signal every other time, when it is judged that the second beam generating device is operating normally and a control section which, when it is judged by the judging section that the second beam generating device is operating normally, performs image formation by using the first beam generating device and the second beam generating device based on the raster signal that is output every other time, and which, when it is judged that the second beam generating device has failed, performs image formation by using only the first beam generating device based on the raster signal that is output each time.

The raster signal processing section according to the fourth invention may include specifically a beam detecting section which outputs a beam detection signal by detecting the first beam deflected by the polygon mirror for scanning, and may be configured to generate the raster signal based on the beam detection signal.

Further, the control section according to the fourth invention may be configured to read the image data from the memory section based on the raster signal.

### BRIEF DESCRIPTION OF THE DRAWINGS

These and other objects and features of the invention will become clear from the following description taken in conjunction with the preferred embodiments thereof with reference to the accompanying drawings, in which:

FIG. 1 is a block diagram showing the essential components of a two-beam scanning optical apparatus according to one embodiment of the present invention.

FIG. 2 is a time chart for the case of two-beam drawing in the two-beam scanning optical apparatus.

FIG. 3 is a time chart for the case of one-beam drawing in the two-beam scanning optical apparatus.

### DETAILED DESCRIPTION OF THE PREFERRED EMBODIMENTS

An embodiment of a two-beam scanning optical apparatus according to the present invention will be described with reference to the accompanying drawings.

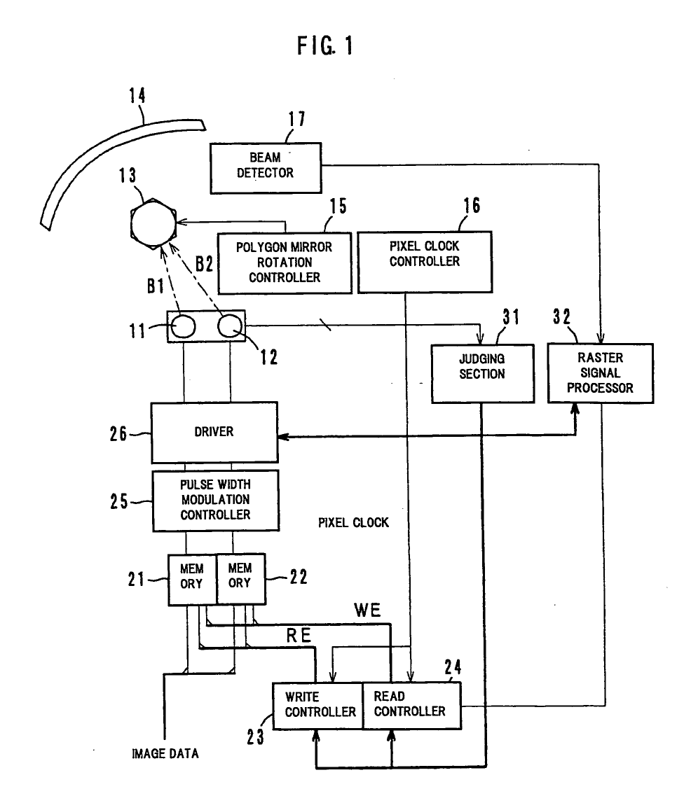

FIG. 1 shows the essential components of the two-beam scanning optical apparatus according to one embodiment of the present invention. The two-beam scanning optical apparatus shown here employs a two-beam image formation method which forms an image onto a photoconductor drum (not shown) by simultaneously projecting a first beam B1 and a second beam B2 one spaced a prescribed distance apart from the other in the sub-scanning direction. Here, if one of the beams, B1 or B2, fails to be produced properly, image formation is performed by using only the other properly produced beam. The details of this will be described later.

The first beam B1 and the second beam B2 are emitted from laser diodes 11 and 12 arranged in an array, and are deflected for scanning in the main scanning direction by means of a polygon mirror 13 rotating at a constant speed; the scanning beams are focused through a scanning lens 14, etc. onto the photoconductor drum on which a two-dimensional electrostatic latent image is formed. Here, the process for forming an image on a photoconductor drum by using one beam or two beams is known in the art, and the process itself will not be described here.

The number of revolutions of the polygon mirror 13 is controlled by a rotation control section 15. The number of revolutions of the polygon mirror 13 that the rotation control section 15 controls is the number of revolutions for forming an image with one beam, and the same number of revolutions is used when forming an image with two beams. That is, when the number of revolutions for forming an image with two beams is denoted by a, then the number of revolutions for forming an image with one beam is 2a, and thus, in the present embodiment, the polygon mirror 13 is driven for rotation with the number of revolutions, 2a, whether when forming an image with two beams or when forming an image with one beam. Here, the rotation speed of the photoconductor drum, i.e., the system speed, is the same whether when forming an image with two beams or when forming an image with one beam.

Image data per line is sequentially input to a first memory section 21 and a second memory section 22. The memory sections 21 and 22 are supplied with a write signal (a write enable signal at a low level) from a write control section 23 and with a read signal (a read enable signal at a low level) from a read control section 24. The write signal and the read signal are each output based on a raster synchronization signal which is output from a raster signal processing section 32 described later.

If one of the laser diodes 11 and 12 fails but the other one is operating normally, the write control section 23 inhibits the writing of the per-line image data to the memory section (21 or 22) corresponding to the failed laser diode, and causes the per-line image data to be written sequentially to the memory section corresponding to the normally operating laser diode. In this case, the read control section 24 performs control so as to sequentially read the per-line image data from the memory section (21 or 22) corresponding to the normally operating laser diode.

The image data read from the memory sections 21 and 22 are transferred via a pulse width modulation control section 25 to a driver section 26 which performs light emission control on the laser diodes 11 and 12. If one of the laser diodes 11 and 12 fails but the other one is operating normally, the driver section 26 performs light emission control on the normally operating laser diode (11 or 12).

A pixel clock control section 16 outputs a pixel clock signal of a prescribed frequency which provides the basis for image formation. The pixel clock to be output here is the frequency used when forming an image with one beam, and the same frequency is used when forming an image with two beams. That is, when the frequency used when forming an image with two beams is denoted by b, then the frequency used when forming an image with one beam is 2b, and thus, in the present embodiment, the clock signal of the frequency 2b is output, whether when forming an image with two beams or when forming an image with one beam.

A judging section 31 detects the light emitting states of the laser diodes 11 and 12, judges whether their light emitting states are normal or abnormal (including the case of device deterioration), and supplies the result of the judgment to the control sections 23 and 24, the driver section 26, and the raster signal processing section 32. The result of the judgment is output in the form of a binary signal: “11” when both the laser diodes 11 and 12 are operating normally; “01” when the laser diode 11 has failed but the laser diode 12 is operating normally; “10” when the laser diode 11 is operating normally but the laser diode 12 has failed; and “00” when both the laser diodes 11 and 12 have failed.

In a specific method of judgment, a sensor can be used to detect the presence or absence of the laser light being emitted from the side opposite to the light emitting side of each of the laser diodes 11 and 12 from which the beam is emitted toward the photoconductor drum.

Alternatively, the judgment may be made based on whether the first beam B1 and the second beam B2 are being detected by a detector 17 (a raster signal detector) which is mounted in a position equivalent to an edge of the image formation area on the surface of the photoconductor drum in order to specify the image write position.

The raster signal processing section 32 supplies the raster synchronization signal to the control sections 23 and 24, based on the beam detection signal output from the detector 17 (the raster signal detector) which detects the deflected/scanned first beam B1 and second beam B2. More specifically, when both the laser diodes 11 and 12 are operating normally, the raster signal processing section 32 generates the raster synchronization signal based on the detection signal of either one of the beams, the first beam B1 or the second beam B2, and transfers the thus generated raster synchronization signal to the control sections 23 and 24. That is, the raster synchronization signal is generated by discarding every other raster signal. On the other hand, when one of the laser diodes 11 and 12 has failed but the other one is operating normally, the raster synchronization signal is generated based on the beam detection signal of the normally operating one (that is, for every line scanned), and the thus generated raster synchronization signal is transferred to the control sections 23 and 24.

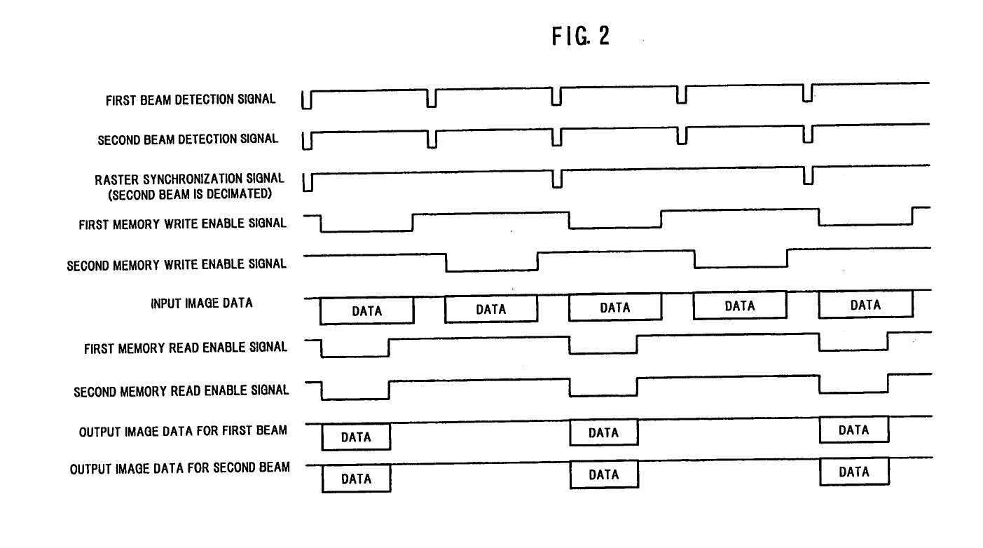

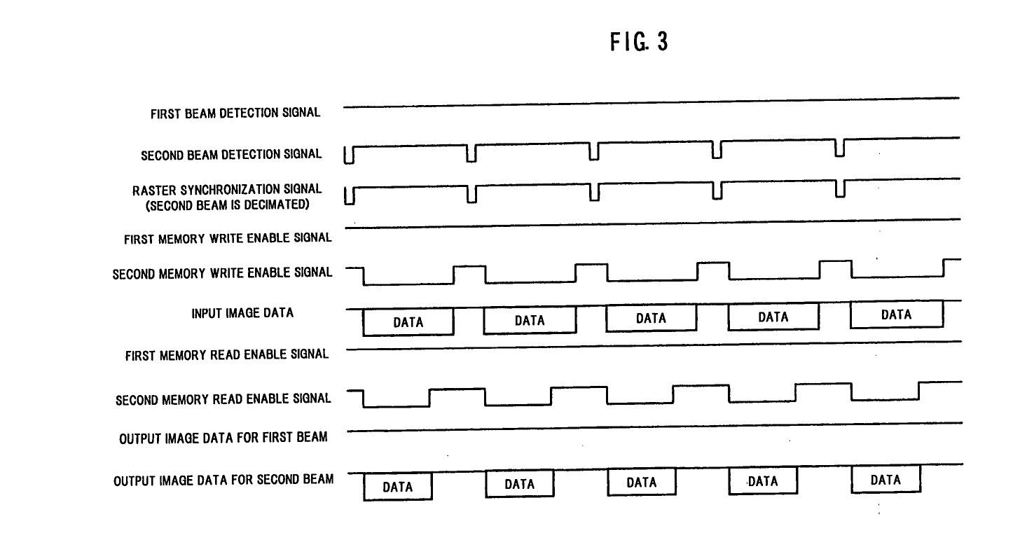

Next, the control operations performed in the thus configured two-beam scanning optical apparatus will be described with reference to FIGS. 2 and 3. FIG. 2 shows a time chart when forming an image with two beams, while FIG. 3 shows a time chart when forming an image with one beam.

When the laser diodes 11 and 12 are operating normally (two-beam image formation, see FIG. 2), the judging section 31 outputs the binary signal “11” which is supplied to the control sections 23 and 24, the driver section 26, and the raster signal processing section 32.

The raster signal processing section 32 that received this signal generates the raster synchronization signal in synchronism with the detection timing of the first beam B1 by discarding the detection signal of the second beam B2 in order to synchronize the image data output timing to the system speed. This means that the raster synchronization signal is generated by decimating the raster signals for every line scanned.

In response to the generation of the raster synchronization signal, the write control section 23 sets the write enable signal to the low level for the first and second memory sections 21 and 22 (with a prescribed delay time provided for the second memory section 22). In this way, the per-line image data are written to the memory sections 21 and 22.

On the other hand, the read control section 24, in response to the generation of the raster synchronization signal, sets the read enable signal to the low level simultaneously for the first and second memory sections 21 and 22. In this way, per-line image data are read from the memory sections 21 and 22, and transferred to the driver section 26 via the pulse width modulation control section 25.

The driver section 26 drives the laser diodes 11 and 12 simultaneously, causing them to emit the beams B1 and B2 modulated by the respectively per-line image data.

As opposed to the case of the two-beam image formation described above, if the laser diode 11 fails but the laser diode 12 is operating normally (one beam image formation, see FIG. 3), the judging section 31 outputs the binary signal “01” which is supplied to the control sections 23 and 24, the driver section 26, and the raster signal processing section 32.

The raster signal processing section 32 that received this signal generates the raster synchronization signal in synchronism with the detection timing of the second beam B2 in order to synchronize the image data output timing to the system speed. This means that the raster synchronization signal is generated for every line scanned.

The write control section 23 holds the write enable signal at the high level for the first memory section 21, thus inhibiting the writing of the image data to the first memory section 21. For the second memory section 22, on the other hand, the write control section 23 sets the write enable signal to the low level in response to the generation of the raster synchronization signal. In this way, the per-line image data is written to the second memory section 22.

Likewise, the read control section 24 holds the read enable signal at the high level for the first memory section 21, thus inhibiting the reading of the data from the first memory section 21. For the second memory section 22, on the other hand, the read control section 24 sets the read enable signal to the low level in response to the generation of the raster synchronization signal. In this way, the per-line image data is read from the second memory section 22, and transferred to the driver section 26 via the pulse width modulation control section 25.

The driver section 26 drives only the normally operating laser diode 12, causing it to emit the beam B2 modulated by the per-line image data.

Conversely, when the laser diode 12 has failed but the laser diode 11 is operating normally, the control operations performed are basically the same as those described with reference to the time chart of FIG. 3, the only difference being that the image is formed using only one beam from the normally operating laser diode 11.

That is, the judging section 31 outputs the binary signal “10” which is supplied to the control sections 23 and 24, the driver section 26, and the raster signal processing section 32. The raster signal processing section 32 that received this signal generates the raster synchronization signal in synchronism with the detection timing of the first beam B1.

The write control section 23 holds the write enable signal at the high level for the second memory section 22, while for the first memory section 21, the write control section 23 sets the write enable signal to the low level in response to the generation of the raster synchronization signal. In this way, the per-line image data is written to the first memory section 21. Likewise, the read control section 24 holds the read enable signal at the high level for the second memory section 22, while for the first memory section 21, the read control section 24 sets the read enable signal to the low level in response to the generation of the raster synchronization signal. In this way, the per-line image data is read from the first memory section 21, and transferred to the driver section 26 via the pulse width modulation control section 25.

The driver section 26 drives only the normally operating laser diode 11, causing it to emit the beam B1 modulated by the per-line image data.

On the other hand, when both the laser diodes 11 and 12 have failed, the judging section 31 outputs the binary signal “00” which is supplied to the control sections 23 and 24, the driver section 26, and the raster signal processing section 32. Upon receiving this signal, the control sections 23 and 24, the driver section 26, and the raster signal processing section 32 respectively stop their control operations.

With the above control operations, even when one of the laser diodes 11 or 12 has failed, image formation can be continued by using the other normally operating laser diode, without reducing the resolution or the system speed compared with the case of two-beam image formation. Even when driving with one beam, since the image quality does not degrade, nor does the printing throughput drop, there is no need to replace the print head unit, which is thus economical.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

For example, the optical system for projecting, deflecting, and scanning the beams B1 and B2 can be configured in any desired way, and also, the detailed configuration of the control system shown in FIG. 1 is not specifically limited.

What is claimed is:

1. A two-beam scanning optical apparatus for forming an image on a photoconductor by simultaneously projecting a first beam and a second beam one spaced a prescribed distance apart from the other in a sub-scanning direction, the apparatus comprising:
a first memory section and a second memory section for holding per-line image data for a first beam generating device and a second beam generating device, respectively;
a judging section which judges whether the first beam generating device and the second beam generating device are operating normally to emit light or a failure has occurred in any one of the beam generating devices;
a memory control section which causes the image data to be written to and read from the first and second memory sections;
a driver section which performs light emission control on the first beam generating device and the second beam generating device;
a rotation control section which controls the rotation of a deflector which deflects the first beam and the second beam for scanning;
a pixel clock control section which outputs a pixel clock signal; and
a raster signal processing section which outputs a raster synchronization signal, and wherein:
the rotation control section drives the deflector for rotation at all times with a number of revolutions that is used when forming an image with one beam,
the pixel clock control section outputs the pixel clock signal at all times with a frequency that is used when forming an image with one beam,
when it is judged by the judging section that one of the beam generating devices has failed but the other beam generating device is operating normally, the memory control section inhibits the writing of the image data to the memory section corresponding to the failed beam generating device, and causes the per-line data to be written to and read from the memory section corresponding to the normally operating beam generating device,
when it is judged by the judging section that one of the beam generating devices has failed but the other beam generating device is operating normally, the driver section performs the light emission control on the normally operating beam generating device, and
when it is judged by the judging section that one of the beam generating devices has failed but the other beam generating device is operating normally, the raster signal processing section generates the raster synchronization signal for each line scanned, while when it is judged by the judging section that the first beam generating device and the second beam generating device are operating normally, the raster signal processing section generates the raster synchronization signal by decimating raster signals.

2. A two-beam scanning optical apparatus as claimed in claim 1, wherein the raster signal processing section is able to select whether the raster synchronization signal should be output based on a detection signal of the first beam or on a detection signal of the second beam, wherein when it is judged by the judging section that one of the beam generating devices has failed but the other beam generating device is operating normally, the raster signal processing section outputs the raster synchronization signal based on the detection signal of the normally operating beam.

3. A two-beam scanning optical apparatus for forming an image on a photoconductor by simultaneously projecting a first beam and a second beam one spaced a prescribed distance apart from the other in a sub-scanning direction, the apparatus comprising:
a deflector which deflects the first beam and the second beam for scanning:
a first memory section and a second memory section for holding per-line image data for a first beam generating device and a second beam generating device, respectively;
a judging section which judges whether the second beam generating device is operating normally to emit light or a failure has occurred in the second beam generating device;
a driver section which performs light emission control on the first beam generating device and the second beam generating device when it is judged by the judging section that the second beam generating device is operating normally, and which performs light emission control only on the first beam generating device when it is judged that the second beam generating device has failed;
a write control section which causes the image data to be written to the first memory section and the second memory section when it is judged by the judging section that the second beam generating device is operating normally, and which causes the image data to be written only to the first memory section when it is judged that the second beam generating device has failed;
a beam detecting section which outputs a beam detection signal by detecting the first beam or the second beam deflected for scanning;
a raster signal processing section which outputs a raster signal each time, based on the beam detection signal, when it is judged by the judging section that the second beam generating device has failed, and which outputs a raster signal every other time, when it is judged that the second beam generating device is operating normally; and
a read control section which causes the image data to be read from the first memory section and the second memory section in accordance with a raster synchronization signal when it is judged by the judging section that the second beam generating device is operating normally, and which causes the image data to be read only from the first memory section in accordance with a raster synchronization signal when it is judged that the second beam generating device has failed.

4. A two-beam scanning optical apparatus for forming an image on a photoconductor by simultaneously projecting a first beam and a second beam one spaced a prescribed distance apart from the other in a sub-scanning direction, the apparatus comprising:
a polygon mirror which deflects the first beam and the second beam for scanning;
a driving section which drives the polygon mirror with a number of revolutions that is used when forming an image only with one beam;
a memory section for holding image data;
a judging section which judges whether a first beam generating device and a second beam generating device are operating normally to emit light or a failure has occurred in any one of the beam generating devices;
a raster signal processing section which outputs a raster signal each time, when it is judged by the judging section that any one of the beam generating devices has failed, and which outputs a raster signal every other time, when it is judged that the beam generating devices are operating normally; and
a control section which, when it is judged by the judging section that the beam generating devices are operating normally, performs image formation by using the first beam generating device and the second beam generating device based on the raster signal that is output every other time, and which, when it is judged that any one of the beam generating devices has failed, performs image formation by using only the normally operating beam generating device based on the raster signal that is output each time.

5. A two-beam scanning optical apparatus as claimed in claim 4, wherein said raster signal processing section includes a beam detecting section which outputs a beam detection signal by detecting the first beam or the second beam deflected by the polygon mirror for scanning, and generates the raster signal based on the beam detection signal.

6. A two-beam scanning optical apparatus for forming an image by projecting a beam, the apparatus comprising:
a first beam generating device;
a second beam generating device;
a rotatable polygon mirror which deflects the first beam and the second beam for scanning;
a memory for holding image data;
a judging unit which judges whether the second beam generating device is operating normally or not;
a raster signal processing unit which outputs a raster signal each time if the judging unit judges that the second beam generating device is operable, and which outputs a raster signal every other time if the judging unit judges that the second beam generating device is not operable; and
a control unit which performs image formation by using the first beam generating device and the second beam generating device based on the raster signal output every other time, and which performs image formation by using only the first beam generating device based on the raster signal output each time.

7. A two-beam scanning optical apparatus as claimed in claim 6, further comprising a driving unit which always drives the polygon mirror with a predetermined number of revolutions.

8. A two-beam scanning optical apparatus as claimed in claim 7, wherein said control unit which, when it is judged by the judging section that the second beam generating device is operating normally, performs image formation by using the first beam generating device and the second beam generating device based on the raster signal that is output every other time, and which, when it is judged that the second beam generating device has failed, performs image formation by using only the first beam generating device based on the raster signal that is output each time.

9. A two-beam scanning optical apparatus as claimed in claim 6, wherein said raster signal processing unit includes a beam detecting unit which outputs a beam detection signal by detecting the first beam deflected by the polygon mirror for scanning, and generates the raster signal based on the beam detection signal.

10. A two-beam scanning optical apparatus as claimed in claim 6, wherein said control unit reads the image data from the memory based on the raster signal.
